(19) United States
(12) Patent Application Publication
(10) Pub. No.: US 2017/0277552 A1
(43) Pub. Date: Sep. 28, 2017

(54) TRACING METHOD, COMPUTER-READABLE RECORDING MEDIUM, AND INFORMATION PROCESSING APPARATUS

(71) Applicant: FUJITSU LIMITED, Kawasaki-shi (JP)

(72) Inventors: Satoshi MUNAKATA, Kawasaki (JP); Toshihiro SHIMIZU, Sagamihara (JP)

(73) Assignee: FUJITSU LIMITED, Kawasaki-shi (JP)

(21) Appl. No.: 15/430,962

(22) Filed: Feb. 13, 2017

(30) Foreign Application Priority Data
Mar. 22, 2016 (JP) 2016-057679

(51) Int. Cl. G06F 9/445; G06F 11/36; G06F 9/44

(52) U.S. Cl. CPC G06F 9/44521; G06F 8/315; G06F 11/3636

(57) ABSTRACT

An information processing apparatus includes receiving a read of a class file created using an object-oriented program language, when a class of the class file is a tracing target, performing class transformation to insert a tracing output process into the class file, when the tracing output process is called during execution of a class file having been subjected to the class transformation, generating a first classloader that reads a tracing class file corresponding to the tracing output process, setting an order of priorities in which the first classloader delegates a read of a class in such a manner that a second classloader having read a class of an object to be passed as an argument to the tracing output process has a highest priority, and causing the first classloader to delegate the read of a class to classloaders in a decreasing order of the priorities from the highest-priority classloader.

### CROSS-REFERENCE TO RELATED APPLICATION

This application is based upon and claims the benefit of priority of the prior Japanese Patent Application No. 2016-057679, filed on Mar. 22, 2016, the entire contents of which are incorporated herein by reference.

### FIELD

The embodiments discussed herein are related to a tracing method, a computer-readable recording medium, and an information processing apparatus.

### BACKGROUND

Java®, C++, and the like are known as object-oriented program languages. A program created using an object-oriented program language is utilized in diverse situations including development of a Web application.

For example, development of a Web application is realized by combining a plurality of pieces of OSS (Open Source Software). In this case, a developer of the OSS and a person in charge of checking the behavior of the OSS are not always the same but are different in many cases. For this reason, there has been a growing need to minimize changes in source codes of the OSS and check the behavior of the OSS from various viewpoints.

When the behavior of OSS is to be checked in this manner, class transformation of plugging an output process of an execution trace, for example, a process of recording an execution result or an internal call result of a method in a class file that is read by a classloader before the classloader interprets the class file as a class may be used.

In a Web application server having a plurality of pieces of OSS combined, a JVM (Java® Virtual Machine) being an execution environment of a Java® program properly uses a plurality of classloaders, which increases situations in which different classes with a same name are used at the same time.

However, the technique described above has cases where occurrence of a cast error at the time of tracing is not suppressed. For example, when an object of a class read by a classloader different from a classloader that has read a class including an execution-trace output process is passed as an argument to the execution-trace output process, a cast error occurs.

### SUMMARY

According to an aspect of an embodiment, a tracing method includes: receiving, by a processor, a read of a class file created using an object-oriented program language; when a class of the class file is a tracing target, performing class transformation to insert a tracing output process into the class file, by the processor; when the tracing output process is called during execution of a class file having been subjected to the class transformation, generating a first classloader that reads a tracing class file corresponding to the tracing output process, by the processor; setting, for each the first classloader, an order of priorities in which the first classloader delegates a read of a class in such a manner that a second classloader having read a class of an object to be passed as an argument to the tracing output process has a highest priority, by the processor; and when a request to the first classloader for a read of a class is issued, causing the first classloader to delegate the read of the class to classloaders in a decreasing order of the priorities from the highest-priority classloader, by the processor.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating a hardware configuration example of an information processing apparatus according to a first embodiment;

FIG. 2 is a diagram illustrating a functional configuration example of the information processing apparatus according to the first embodiment;

FIG. 3 is a diagram illustrating an example of class transformation;

FIG. 4 is a diagram illustrating an example of a Trace class file;

FIG. 5 is a sequence diagram illustrating an example of a tracing process;

FIG. 6 is a sequence diagram illustrating an example of a process in a case where a plurality of classloaders are used;

FIG. 7 is a sequence diagram illustrating an example of a tracing process in a case where a plurality of classloaders are used;

FIG. 8 is a diagram illustrating an example of a correlation among classes and objects;

FIG. 9 is a diagram illustrating examples of a Trace code;

FIG. 10 is a diagram illustrating examples of a Trace code;

FIG. 11 is a diagram illustrating an example of a method of managing tracing classloaders;

FIG. 12 is a diagram illustrating an example of a method of setting the order of priorities;

FIG. 13 is a diagram illustrating an example of a correlation among classes and objects;

FIG. 14 is a flowchart illustrating a procedure of a tracing process according to the first embodiment (1);

FIG. 15 is a flowchart illustrating a procedure of the tracing process according to the first embodiment (2); and

FIG. 16 is a flowchart illustrating a subroutine of the tracing process according to the first embodiment.

### DESCRIPTION OF EMBODIMENTS

Preferred embodiments will be explained with reference to accompanying drawings. The disclosed techniques are not limited to the embodiments. The respective embodiments can be combined to each other as appropriate within a scope where processing contents thereof do not contradict to one another.

### [a] First Embodiment

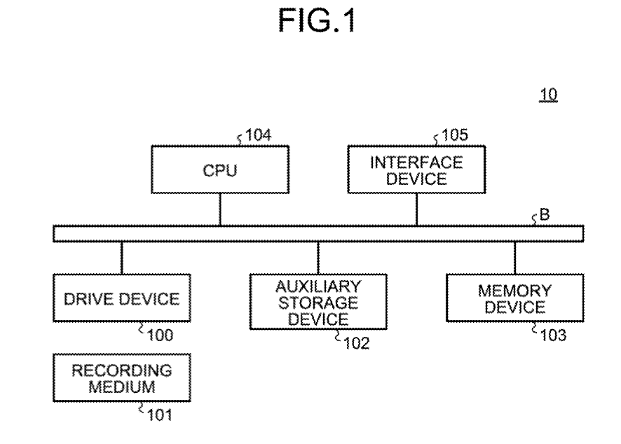

FIG. 1 is a diagram illustrating a hardware configuration example of an information processing apparatus according to a first embodiment. As illustrated in FIG. 1, an information processing apparatus 10 has a drive device 100, an auxiliary storage device 102, a memory device 103, a CPU 104, an interface device 105, and the like. The drive device 100, the auxiliary storage device 102, the memory device 103, the CPU 104, and the interface device 105 are mutually connected with a bus B.

A program that realizes processing in the information processing apparatus 10 is provided by a recording medium 101 as an example. When the recording medium 101 having the program recorded thereon is set to the drive device 100, the program is installed in the auxiliary storage device 102 via the drive device 100. Installation of a program is not always performed via the recording medium 101 and can be downloaded from another computer via a network. The auxiliary storage device 102 has the installed program stored therein and also has files, data, and the like used for processing performed by the CPU 104 stored therein.

When a start instruction on a program is issued, the memory device 103 reads the program from the auxiliary storage device 102 and stores the read program therein. The CPU 104 executes a function associated with the information processing apparatus 10 according to the program stored in the memory device 103. The interface device 105 is used as an interface for connecting to a network.

An example of the recording medium 101 is a transportable recording medium such as a CD-ROM, a DVD disk, or a USB memory. An example of the auxiliary storage device 102 is an HDD (Hard Disk drive) or a flash memory. The recording medium 101 and the auxiliary storage device 102 both correspond to a computer-readable recording medium.

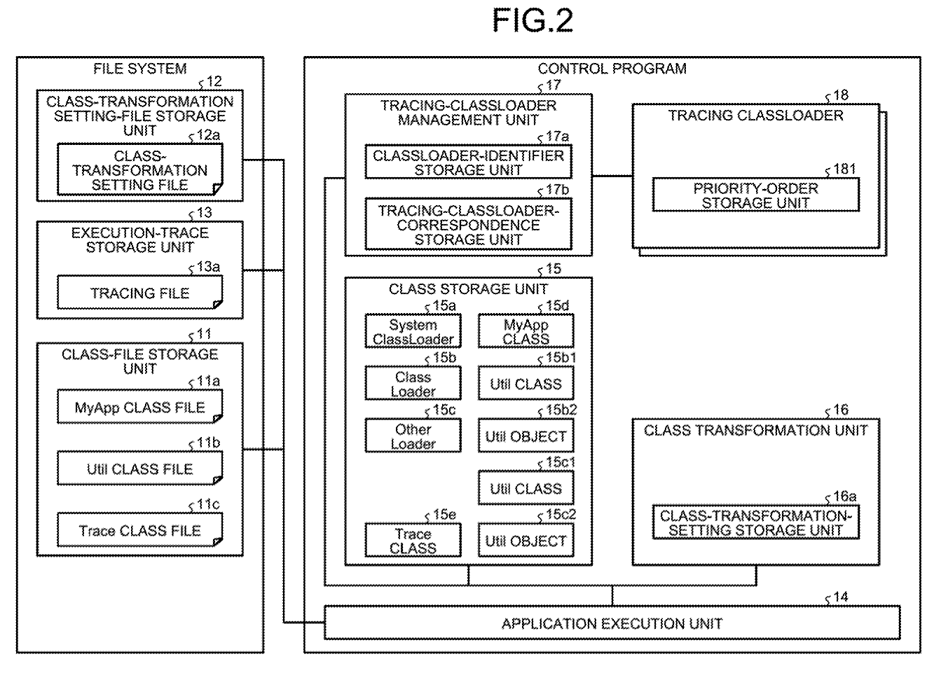

FIG. 2 is a diagram illustrating a functional configuration example of the information processing apparatus according to the first embodiment. As illustrated in FIG. 2, the information processing apparatus 10 has storage units including a class-file storage unit 11, a class-transformation setting-file storage unit 12, and an execution-trace storage unit 13. These storage units are merely examples and are realized by a file system using the auxiliary storage device 102, a storage device connected to the information processing apparatus 10 via a network, or the like. Some or all of the storage units are realized by using a part of a work area included in the memory device 103.

The class-file storage unit 11 is a storage unit that has class files stored therein.

As an embodiment thereof, class files each including a byte code obtained by compiling a source file described in a Java® language using a JVM (Java® Virtual Machine) are stored in the class-file storage unit 11. Class files are stored in the class-file storage unit 11 in a state persisted using an O/R mapping tool, or the like. For example, a MyApp class file 11a, a Util class file 11b, and a Trace class file 11c are stored in the class-file storage unit 11. Although not illustrated in FIG. 2, storage of a classloading class, that is, a class file of a classloader, a class file related to a general-purpose library, and the like in the class-file storage unit 11 is not eliminated.

The MyApp class file 11a and the Util class file 11b are implemented as various application programs to be executed in an environment provided by the JVM or the like, for example, as Web applications. The MyApp class file 11a and the Util class file 11b, in each of which a source file programmed by a developer of Web applications or the like is compiled, are stored as an example in the class-file storage unit 11. For example, a main method executed first in a MyApp class as well as a definition of the MyApp class is included in the MyApp class file 11a.

The Trace class file 11c is programmed by a person in charge of checking a Web application or the like to output an execution trace of the Web application for the purpose of being used to understand the behavior of the Web application, find a bottleneck, and generate a call graph. For example, class transformation in which an output process of an execution trace defined in the Trace class file 11c is plugged in a Java® program as an observation target is performed to realize the execution trace of a Web application. For example, the Trace class file 11c includes a definition of a Trace class and a write method in which an output process of an execution trace is described.

While a case where Java® class files are stored is described merely as an example, class files, in each of which a source file described in another object-oriented programming language is compiled, can be stored. Furthermore, class files are not always stored. For example, source files instead of class files can be stored in a storage unit and the source files can be complied in a situation where a Web application is to be executed.

The class-transformation setting-file storage unit 12 is a storage unit that has a class-transformation setting file 12a stored therein. The “class-transformation setting file” indicates a setting file to be referred to at the time of class transformation described above, and can be described in, for example, an XML (Extensible Makeup Language) format or a CSV (Comma-Separated Values) format. The class-transformation setting file 12a can receive setting contents from a person in charge of checking a Web application or the like via an interface such as javaagent. The setting contents can include contents of information to be logged at the time of tracing and also a designation of a method to be used in a Trace class for relevant tracing, as well as a class or a method to be traced, as an example.

The execution-trace storage unit 13 is a storage unit that stores therein a result of an execution trace. For example, a tracing file 13a in which information output by a method of a Trace class is accumulated in a chronological order is stored in the execution-trace storage unit 13.

As illustrated in FIG. 2, the information processing apparatus 10 also has an application execution unit 14, a class storage unit 15, a class transformation unit 16, a tracing-classloader management unit 17, tracing classloaders 18, and the like. These processing units are realized by processing that a control program installed in the information processing apparatus 10 causes the CPU 104 to perform. In this example, “application (app)” of the application execution unit 14 described above is an abbreviation of an application program.

The application execution unit 14 is a processing unit that executes a Java® program.

As an embodiment, the application execution unit 14 is implemented by causing the JVM described above or the like to run. As a result of provision of an execution environment of Java® using the JVM, execution of a Java® program is enabled. When the JVM is started in this way, various classloaders such as a bootstrap classloader, an extended classloader, a SystemClassLoader are loaded. Furthermore, the JVM can transform a class file immediately before a classloader reads the class file.

The class storage unit 15 is a storage unit that has classes stored therein.

As one embodiment, each time a class file stored in the class-file storage unit 11 is loaded to the memory device 103, identification information such as a class name and an identifier related to the class for which the load has been performed is stored in the class storage unit 15. Furthermore, each time an object is generated from a class, identification information such as an object name and an identifier related to the object generated from the class is stored in the class storage unit 15. Accordingly, identification information of a class or an object running on the information processing apparatus 10 is managed by the class storage unit 15. Examples of a class running on the information processing apparatus 10 include a classloading class, an application executing class, and a tracing outputting class.

The class transformation unit 16 is a processing unit that transforms a class file to be read by a class loader.

As one embodiment, the class transformation unit 16 is implemented as a ClassTransformer by an implementation class of “Java®.lang.instrument.ClassFileTransformer” or the like. The class transformation unit 16 has a class-transformation-setting storage unit 16a. Class transformation setting obtained by duplicating the class-transformation setting file 12a stored in the class-transformation setting-file storage unit 12 is stored in the class-transformation-setting storage unit 16a.

Plug-in of Tracing Process

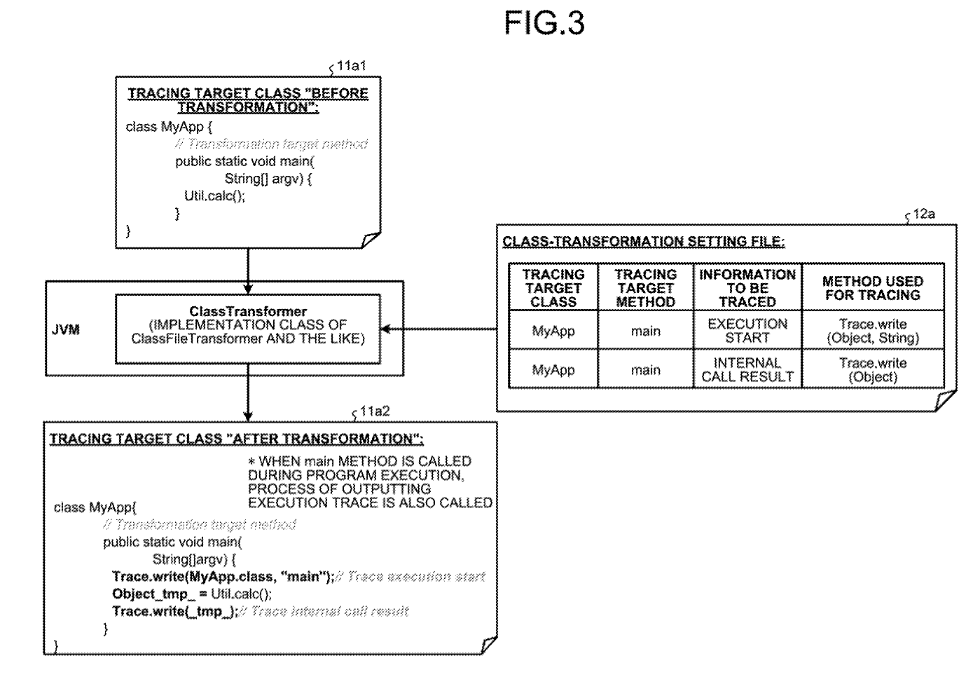

Plug-in of the tracing process is described here. FIG. 3 is a diagram illustrating an example of class transformation. In FIG. 3, a case where a designation of a MyApp class as a class to be executed first and a designation of the class-transformation setting file 12a as setting to be used for class transformation are received via an input device or a network is assumed. In FIG. 3, sign 11a1 is attached to a MyApp class file as a tracing target class before transformation, sign 12a is attached to a class-transformation setting file to be referred to at the time of class transformation, and sign 11a2 is attached to a MyApp class file as a tracing target class after transformation. While source codes of respective class files are illustrated in FIG. 3 for convenience sake, it goes without saying that the class files are actually binary files. Comment texts in the source codes are represented in italics.

As illustrated in FIG. 3, when the MyApp class file 11a1 before transformation is input to the ClassTransformer, the ClassTransformer refers to the class-transformation setting file 12a.

For the class-transformation setting file 12a, interpretation of setting described below is performed with respect to a main method to be traced in a MyApp class as a tracing target. For example, when information to be traced is “execution start”, a method to be used for tracing is called at the head of a definition block of a target method using a declarative class and a name of the target method as arguments. When information to be traced is “internal call result”, a method to be used for tracing is called using a return value of a method call expression included in a definition block of a target method as an argument.

Referring to the class-transformation setting file 12a, the ClassTransformer plugs the output process of an execution trace defined in the Trace class file 11c into the MyApp class file 11a1 before transformation to transform the MyApp class file 11a1 to the MyApp class file 11a2.

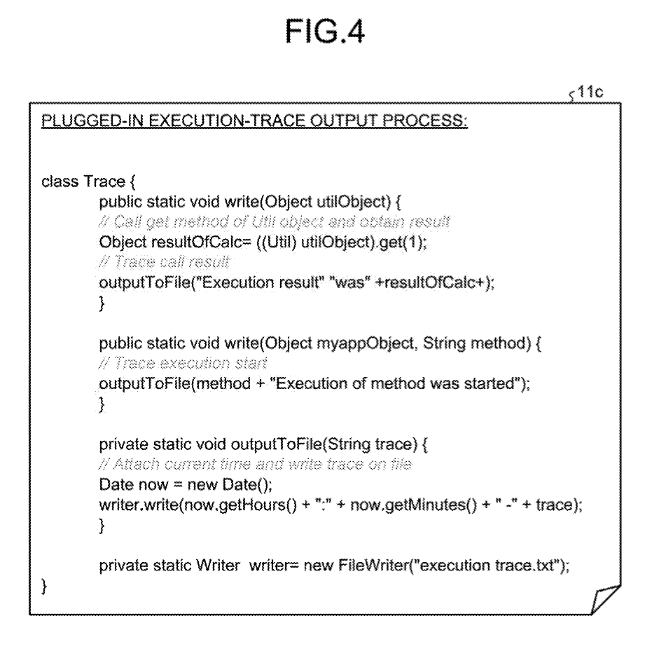

FIG. 4 is a diagram illustrating an example of the Trace class file 11c. Also in FIG. 4, source codes of the Trace class file 11c are illustrated and comment texts in the source codes are represented in italics for convenience sake. However, it goes without saying that the class file is a binary file. A mechanism of storing an execution trace in an external file, that is, the tracing file 13a when a write method of the Trace class is called is described in the Trace class file 11c illustrated in FIG. 4.

After the class file transformation, the ClassTransformer outputs the transformed MyApp class file 11a2 to a classloader.

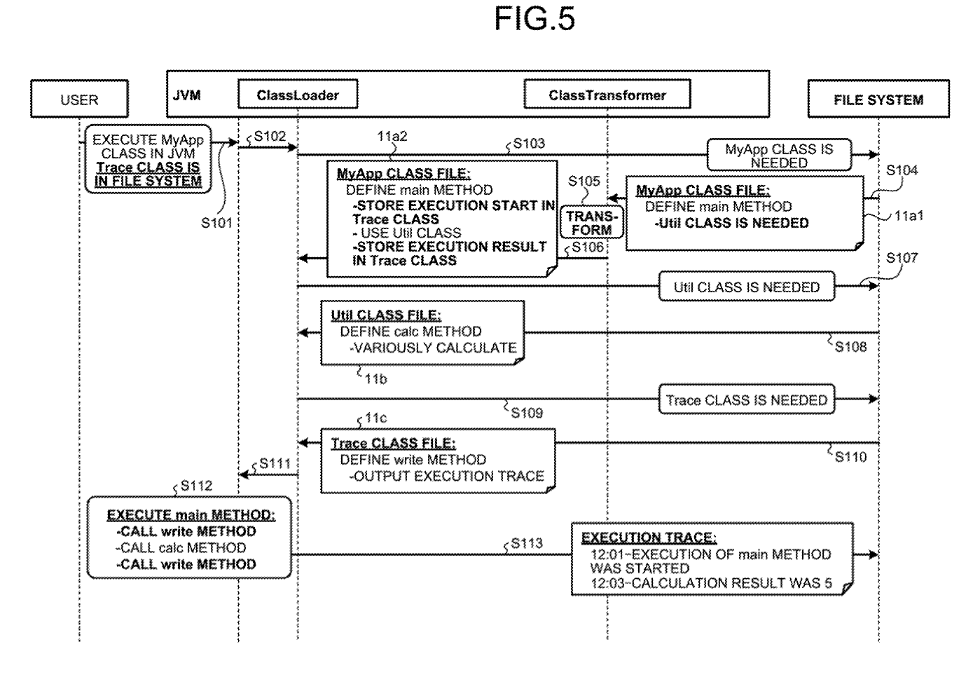

FIG. 5 is a sequence diagram illustrating an example of a tracing process. In the sequence diagram illustrated in FIG. 5, a user, a JVM, a ClassLoader 15b and a ClassTransformer running in a Java® execution environment, and a file system are illustrated as execution agents of the process. A user does not mean a fact that a process execution agent is a human but means a user input that is input via a CLI (Common Language Infrastructure), or the like by a developer or a person in charge of checking as a user. Such a user input can be performed via an input device or via a network.

As illustrated in FIG. 5, a user input designating a MyApp class as a class to be executed first, and a user input indicating that a Trace class is in the file system are performed to the JVM via an input device or a network (Step S101).

The JVM then instructs the ClassLoader 15b to read the MyApp class file 11a (Step S102). Next, the ClassLoader 15b requests the MyApp class file 11a from the file system (Step S103). At that time, the ClassLoader 15b notifies the position of the Trace class file 11c with an execution argument of the JVM.

Subsequently, the file system outputs the MyApp class file 11a1 stored in the class-file storage unit 11 to the ClassTransformer (Step S104). The ClassTransformer plugs the execution-trace output process defined in the Trace class file 11c according to the class-transformation setting file 12a into the MyApp class file 11a1 to transform the MyApp class file 11a1 to the MyApp class file 11a2 (Step S105).

This class transformation provides the MyApp class file 11a2 in which two tracing processes of a process of recording an execution start in the Trace class and a process of recording an execution result in the Trace class as well as the definition of the main method defined in the MyApp class file 11a1, that is, use of the Util class are plugged in. Next, the ClassTransformer outputs the MyApp class file 11a2 transformed at Step S105 to the ClassLoader 15b (Step S106).

The ClassLoader 15b having checked the definition of the main method in the MyApp class file 11a2 performs following processes. That is, the ClassLoader 15b requests the Util class file 11b from the file system (Step S107). As a result, the ClassLoader 15b acquires the Util class file 11b from the file system (Step S108). The ClassLoader 15b also requests the Trace class file 11c from the file system (Step S109). As a result, the ClassLoader 15b acquires the Trace class file 11c from the file system (Step S110).

Subsequently, the ClassLoader 15b outputs the MyApp class file 11a2, the Util class file 11b, and the Trace class file 11c to the JVM (Step S111).

The JVM executes a main method of a MyApp class 15d loaded by the ClassLoader 15b (Step S112). A write method of recording an execution start of the main method and a write method of recording an execution result of a calc method of a Util class 15b1 are inserted into the main method. Subsequently, the JVM outputs a result of an execution trace, that is, an execution start of the main method and an execution result of the calc method to the tracing file 13a in the file system (Step S113).

When the plugged-in execution-trace output process is performed, for example, when an observation target class is transformed to call a write method of the Trace class in the example illustrated in FIG. 4, tracing can be readily realized.

Use of Plurality of Classloaders

In development of a Web application or the like, a situation where a plurality of pieces of OSS (Open Source Software) are combined to realize a Web application server increases. In a Web application server in which a plurality of pieces of OSS are combined, a JVM properly uses a plurality of classloaders to use different classes with a same name at the same time.

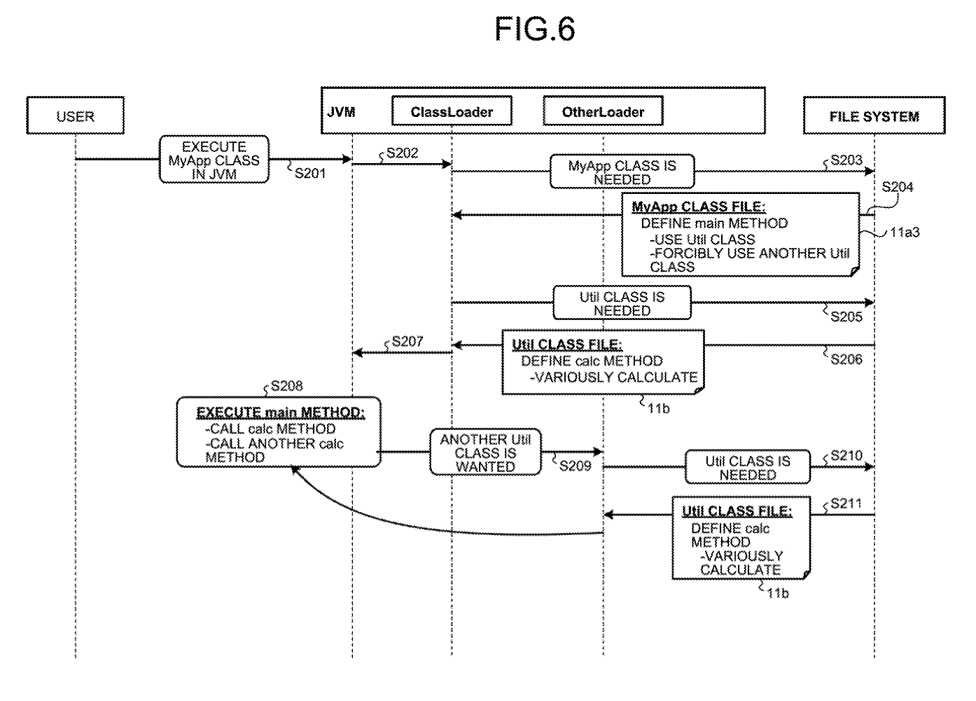

FIG. 6 is a sequence diagram illustrating an example of a process in a case where a plurality of classloaders are used. In FIG. 6, a process of plugging in the execution-trace output process is not incorporated and the ClassTransformer is not included in process execution agents for convenience sake. Meanwhile, two classloaders including an OtherLoader 15c as well as the ClassLoader 15b are included in the process execution agents in FIG. 6.

As illustrated in FIG. 6, a user input designating the MyApp class as a class to be first executed is performed to the JVM via an input device or a network (Step S201).

The JVM then instructs the ClassLoader 15b to read the MyApp class file 11a (Step S202). Next, the ClassLoader 15b requests a MyApp class file 11a3 from the file system (Step S203). As a result, the ClassLoader 15b acquires the MyApp class file 11a3 from the file system (Step S204). As well as the definition of the main method prescribed in the MyApp class file 11a1 illustrated in FIG. 5, that is, use of the Util class, a definition to forcibly use another Util class is also included in the MyApp class file 11a3.

The ClassLoader 15b having checked the definition of the main method in the MyApp class file 11a3 performs following processes. That is, the ClassLoader 15b requests the Util class file 11b from the file system (Step S205). As a result, the ClassLoader 15b acquires the Util class file 11b from the file system (Step S206).

Subsequently, the JVM acquires the MyApp class file 11a3 and the Util class file 11b loaded by the ClassLoader 15b (Step S207). Next, the JVM executes the main method of the MyApp class 15d loaded by the ClassLoader 15b (Step S208).

In the main method executed in this manner at Step S208, call of the calc method of the Util class 15b1 and call of another calc method are defined. That is, although the same classloader as a classloader having called a class that includes a method being executed is normally used also for reading of a dependent class (Util class), an arbitrary class can be read by an arbitrary classloader when designated explicitly. Accordingly, the JVM instructs the OtherLoader 15c different from the ClassLoader 15b to read the Util class file 11b according to the definition of the main method (Step S209).

In response thereto, the OtherLoader 15c requests the Util class file 11b from the file system (Step S210). As a result, the OtherLoader 15c acquires the Util class file 11b from the file system (Step S211).

With these series of processes, the JVM can simultaneously use different classes with a same name, that is, classes having a same class name and being read from a same class file while being different as data on a memory.

One Example of Error Caused by Plurality of Classloaders

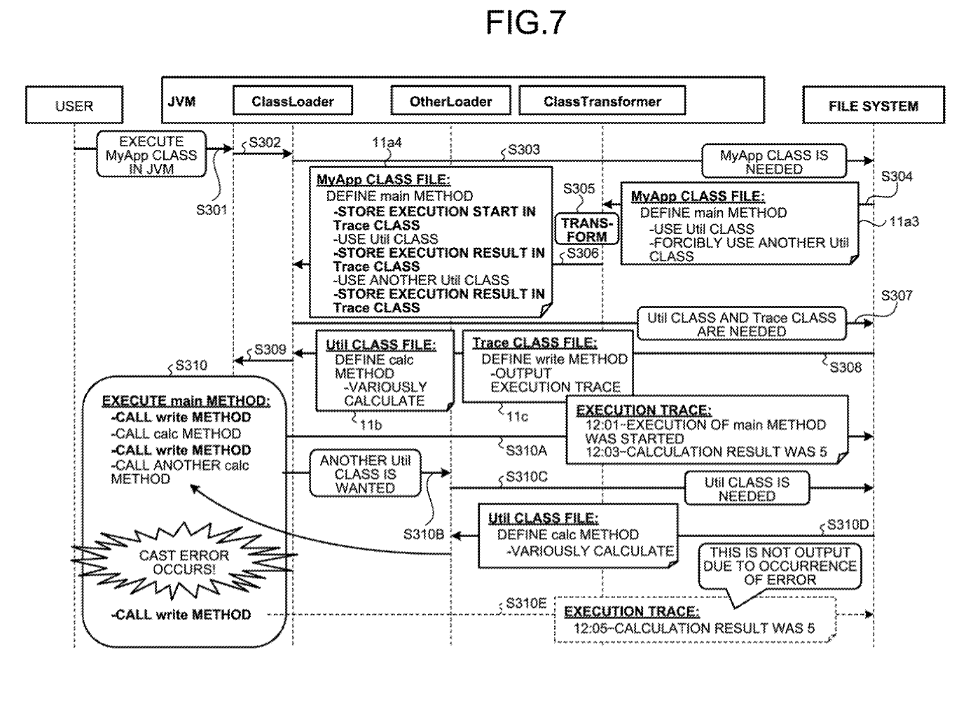

In a case where a plurality of classloaders are used, an abnormal stop may occur due to occurrence of an error when different classes with a same name are traced. FIG. 7 is a sequence diagram illustrating an example of a tracing process in a case where a plurality of classloaders are used. In FIG. 7, an example in which the ClassTransformer is further included in process execution agents as compared to FIG. 6 and a cast error occurs at the time of execution of a tracing process is illustrated.

As illustrated in FIG. 7, a user input designating the MyApp class as a class to be first executed is performed to the JVM via an input device or a network (Step S301).

The JVM then instructs the ClassLoader 15b to read the MyApp class file 11a (Step S302). Next, the ClassLoader 15b requests the MyApp class file 11a from the file system (Step S303).

Subsequently, the file system outputs the MyApp class file 11a3 stored in the class-file storage unit 11 to the ClassTransformer (Step S304). The ClassTransformer plugs the output process of the execution trace defined in the Trace class file 11c into the MyApp class file 11a3 according to the class-transformation setting file 12a to transform the MyApp class file 11a3 to a MyApp class file 11a4 (Step S305).

With the class transformation, the MyApp class file 11a4 in which the definition of the main method prescribed in the MyApp class file 11a3, that is, three processes of a process of recording an execution start of the main method in the Trace class, a process of recording an execution result of a calc method of the Util class in the Trace class, and a process of recording an execution result of the calc method of another Util class in the Trace class as well as use of the Util class and forcible use of another Util class are plugged is obtained.

Next, the ClassTransformer outputs the MyApp class file 11a4 transformed at Step S305 to the ClassLoader 15b (Step S306).

The ClassLoader 15b having checked the definition of the main method in the MyApp class file 11a4 performs following processes. That is, the ClassLoader 15b requests the Util class file 11b and the Trace class file 11c from the file system (Step S307). As a result, the ClassLoader 15b acquires the Util class file 11b and the Trace class file 11c from the file system (Step S308).

Subsequently, the ClassLoader 15b outputs the MyApp class file 11a4, the Util class file 11b, and the Trace class file 11c to the JVM (Step S309).

The JVM performs the main method of the MyApp class 15d loaded by the ClassLoader 15b (Step S310). The main method has the three tracing processes of the process of recording an execution start of the main method, the process of recording an execution result of the calc method of the Util class 15b1, and the process of recording an execution result of the calc method of another Util class 15c1 inserted thereto.

Among these processes, the process of recording an execution start of the main method and the process of recording an execution result of the calc method of the Util class 15b1 are successfully performed. This is because a method of a Trace class 15e that receives a Util object 15b2 obtained by instantiating the Util class 15b1 as an argument has been read by the same ClassLoader 15b. That is, the JVM outputs a result of the execution trace, that is, the execution start of the main method and the execution result of the calc method to the tracing file 13a in the file system (Step S310A).

Meanwhile, the process of recording an execution result of the calc method of another Util class 15c1 fails. That is, the JVM instructs the OtherLoader 15c different from the ClassLoader 15b to read the Util class file 11b according to the definition of the main method (Step S310B). In response thereto, the OtherLoader 15c requests the Util class file 11b from the file system (Step S310C). As a result, the OtherLoader 15c acquires the Util class file 11b from the file system (Step S310D).

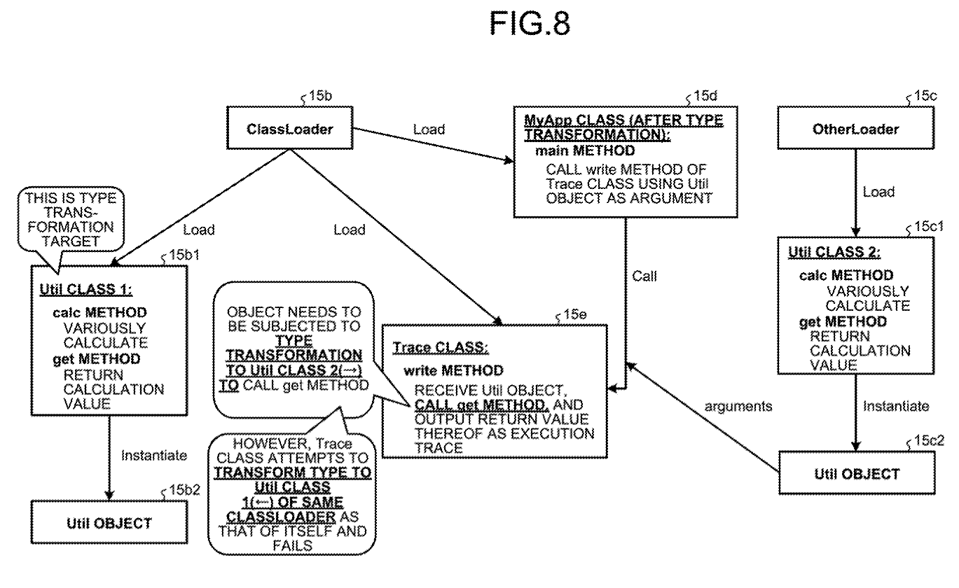

A write method of the Trace class 15e is called using a Util object 15c2 obtained by instantiating another Util class 15c1 read by the OtherLoader 15c as an argument. At that time, the write method of the Trace class 15e checks the ClassLoader 15b having the Trace class 15e read therein to attempt to analyze a calling method of the calc method. However, the Classloader 15b having the Trace class 15e read therein is different from the OtherLoader 15c having another Util class 15c1 read therein. Therefore, a cast error occurs as will be described later with reference to FIG. 8. As a result, the JVM is not possible to perform a process at Step S310E of outputting an execution result of the calc method of another Util class 15c1 read by the OtherLoader 15c to the tracing file 13a in the file system.

FIG. 8 is a diagram illustrating an example of a correlation among classes and objects. In FIG. 8, classes read by the ClassLoader 15b, an object obtained by instantiating the classes, a class read by the OtherLoader 15c, and an object obtained by instantiating the class are illustrated.

As illustrated in FIG. 8, the write method of the Trace class 15e is called using the Util object 15c2 obtained by instantiating the Util class 15c1 read by the OtherLoader 15c as an argument. The write method of the Trace class 15e receives the Util object 15c2 to call a get method and attempts to output a return value thereof as an execution trace.

When a get method is to be called, cast is successfully performed when the type of an object can be converted to the Util class 15c1. However, this process is not available for the write method of the Trace class 15e. This is because the type of the write method of the Trace class 15e is attempted to be converted to the Util class 15b1 read by the ClassLoader 15b having the Trace class 15e read therein. As described above, the Util class 15b1 read by the ClassLoader 15b and the Util class 15c1 read by the OtherLoader 15c are different substances even if these classes are read from a same class file, and accordingly mutual type conversion is not possible to be performed. As a result, a cast error occurs.

As described above, in a case where a method of a tracing class read by a classloader A receives an object C of a class read by a classloader B as an argument, a cast error occurs when the object C is attempted to be used as a class B during processing.

Use of Reflection

It is also conceivable that a cast error is avoided by operating an object as an argument using “reflection” in the Trace class 15e illustrated in FIG. 8. In this case, “reflection” means a mechanism to operate an own structure of a program as data. When a method is called using the “reflection”, the cast error described above can be suppressed.

That is, the write method of the Trace class 15e having received the Util object 15c2 calls a get method using the reflection and outputs a return value thereof as an execution trace. When the reflection is used in this way, the Util class 15c1 obtained by actually instantiating the Util object 15c2 is acquired and a get method of that class is returned. Therefore, no cast error occurs.

Adverse Effect Caused by Use of Reflection

When the reflection is used, many development support functions are disabled for tracing as described below. For example, functions such as (1) type checking at the time of compilation (also at the time of coding during use of IDE), (2) code complementation at the time of coding, and (3) refactoring (particularly, automatic transformation of a method name) at the time of coding are disabled.

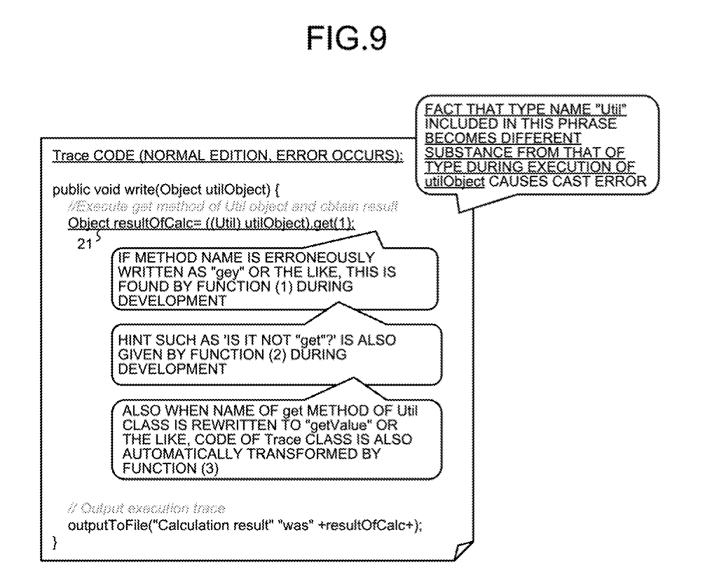

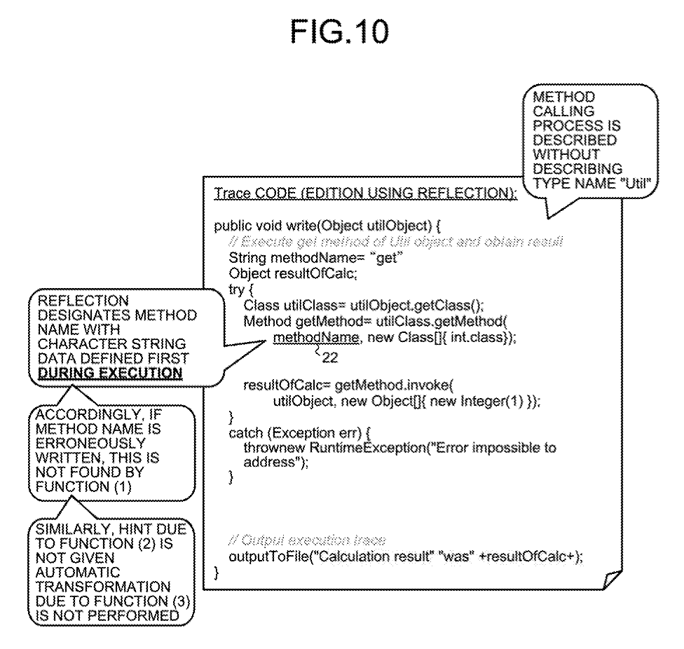

FIGS. 9 and 10 are diagrams illustrating examples of a Trace code. In FIGS. 9 and 10, Trace codes for performing class transformation to perform a tracing process are illustrated. While a Trace code for which the reflection is not used is illustrated in FIG. 9, a Trace code for which the reflection is used is illustrated in FIG. 10.

For example, even when a method included in a text of an underlined part 21 in a Trace code illustrated in FIG. 9 is erroneously described as “gey” instead of “get”, this is found by the function (1) described above during development. Furthermore, a hint such as ‘Do you mean “get”?’ is given by the function (2) described above. Additionally, also when the name of a get method of the Util class is rewritten to “getValue” or the like, a code of the Trace class 15e is also automatically transformed by the function (3) described above. As described above, when the reflection is not used, the functions (1) to (3) described above can be utilized effectively.

On the other hand, when the reflection is used, a method name is designated by character string data that is decided first at the time of execution as in an underlined part 22 of a Trace code illustrated in FIG. 10. Accordingly, if the method name is erroneously written, this is not found by the function (1) described above and no hint is given by the function (2) described above. Furthermore, automatic transformation due to the function (3) described above is not performed.

As described above, use of the reflection can suppress occurrence of the cast error described above as compared to a case where the reflection is not used. However, a restriction occurs that the functions (1) to (3) described above are not utilized effectively. When these development support functions are disabled, the maintainability of a program is greatly lowered. Furthermore, the reflection is more difficult to read than other codes and thus the execution speed is reduced by about ten times.

One Aspect of Objective

Due to the above configurations, the present embodiment has one aspect that a tracing method that can perform a process of “calling a method of a class using an object as a receiver” described without using the reflection, with no cast error occurring, so as to be capable of applying various types of development support functions, for example, the functions (1) to (3) described above also when an object of a class read by a different classloader from a classloader having read a class including an execution-trace output process is passed as an argument to the execution-trace output process is applied, so that execution-trace output contents of a “Java® program properly using a plurality of classloaders” can be more readily changed.

The tracing-classloader management unit 17 and the tracing classloaders 18 are implemented in the present embodiment to realize the tracing method described above.

Tracing-Classloader Management Unit 17

The tracing-classloader management unit 17 is a processing unit that manages the tracing classloaders 18 based on the equivalent of an ordered set of identifiers of classloaders to which the tracing classloaders 18 delegates reading.

As an embodiment, each time the process of outputting an execution trace is called, that is, each time a call expression for the write method of the Trace class 15e is executed, the tracing-classloader management unit 17 determines whether a classloader-identifier storage unit 17a has an identifier corresponding to a classloader having read a class of an object passed as an argument of the write method registered therein.

For the classloader-identifier storage unit 17a, a data structure in which classloaders and identifiers are associated with each other is adopted. For example, the classloader-identifier storage unit 17a can be realized by a Java® associative array using a reference of a classloader being an object as a key and using an identifier as a value. An “identifier” is not limited to a number or an alphabetical character and an arbitrary character string can be adopted. Each time a classloader other than the SystemClassLoader is read, an address on a memory at which the classloader is stored can be stored in the key of a classloader.

With this configuration of the classloader-identifier storage unit 17a, the tracing-classloader management unit 17 numbers a unique identifier when an identifier corresponding to a classloader having read a class of an object passed as an argument of the write method is not registered in the classloader-identifier storage unit 17a. A method of assigning numbers in the ascending or descending order can be adopted as an example of a method of numbering identifiers. The tracing-classloader management unit 17 then stores a previously numbered identifier in the classloader-identifier storage unit 17a to be associated with the key of the classloader.

Subsequently, each time a new identifier is added to the classloader-identifier storage unit 17a, the tracing-classloader management unit 17 generates an ordered set having the new identifier as an element. The tracing-classloader management unit 17 generates a tracing classloader 18 that has a classloader having read a class of an object passed as an argument of a write method as a delegation destination. The tracing-classloader management unit 17 then sets the previously-generated ordered set as a key and the previously-generated tracing classloader 18 as a value to store a correspondence relation therebetween in a tracing-classloader-correspondence storage unit 17b.

The tracing-classloader management unit 17 requests the previously-generated tracing classloader 18 to read the Trace class file 11c stored in the class-file storage unit 11. Subsequently, the tracing-classloader management unit 17 obtains the Trace class file 11c read by the tracing classloader 18 and outputs the Trace class file 11c to the application execution unit 14 that executes a Java® program. When the tracing classloader 18 is already generated, the Trace class 15e read by the tracing classloader 18 is output to the application execution unit 14.

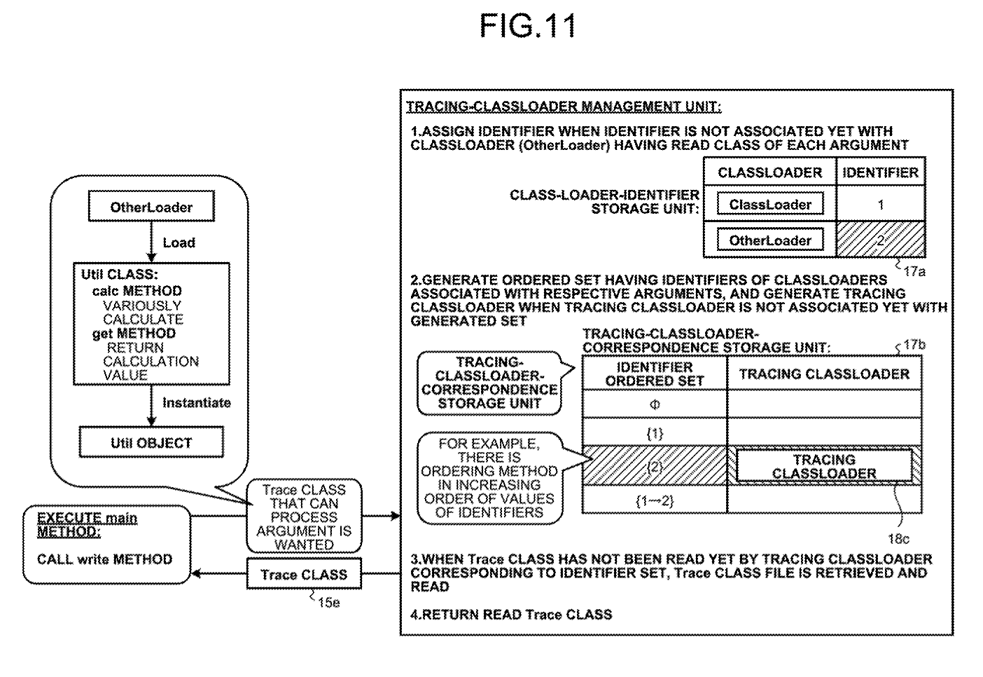

FIG. 11 is a diagram illustrating an example of a method of managing tracing classloaders. In FIG. 11, a situation in which, after the Util object 15b2 is generated from the Util class 15b1 read by the ClassLoader 15b and then a write method of the Trace class 15e is executed, the Util object 15c2 is generated from the Util class 15c read by the OtherLoader 15c is assumed.

As illustrated in FIG. 11, when the main method of the MyApp class 15d loaded by the ClassLoader 15b is to be executed, the JVM executes a call expression for the write method of the Trace class 15e in the main method. At that time, the JVM requests the tracing-classloader management unit 17 to load the Trace class 15e that is processed using the object of the Util class 15c1 as an argument.

The tracing-classloader management unit 17 then determines whether the classloader-identifier storage unit 17a has an identifier corresponding to the OtherLoader 15c that has read the class of the Util object 15c2 passed as an argument of the write method registered therein. At that time, when the classloader-identifier storage unit 17a does not have the identifier corresponding to the OtherLoader 15c registered therein, an identifier “2” following an identifier “1”, which is a number given to the ClassLoader 15b, continuing in the ascending order is given to the OtherLoader 15c as an example. As a result, “2” being a value is stored in the classloader-identifier storage unit 17a to be associated with the OtherLoader 15c being a key as indicated in a hatched portion in FIG. 11.

As described above, when a new identifier is added to the classloader-identifier storage unit 17a, the tracing-classloader management unit 17 generates an ordered set {2} having the new identifier “2” as an element. The tracing-classloader management unit 17 then generates a tracing classloader 18c having the OtherLoader 15c that has read a class of an object passed as an argument of the write method as a delegation destination. The tracing-classloader management unit 17 then sets the previously-generated ordered set {2} as a key and the previously-generated tracing classloader 18c as a value to store a correspondence relation therebetween in the tracing-classloader-correspondence storage unit 17b.

The tracing-classloader management unit 17 requests the previously-generated tracing classloader 18 to read the Trace class file 11c stored in the class-file storage unit 11. Subsequently, the tracing-classloader management unit 17 obtains the Trace class file 11c read by the tracing classloader 18c and outputs the Trace class file 11c to the application execution unit 14 that executes a Java® program.

Tracing Classloader 18

The tracing classloaders 18 are classloaders that read the Trace class file 11c.

As one embodiment, a tracing classloader 18 is generated by the tracing-classloader management unit 17 with respect to each of ordered sets stored in the tracing-classloader-correspondence storage unit 17b. For example, in the example illustrated in FIG. 11, when the identifier “1” of the ClassLoader 15b is stored in the classloader-identifier storage unit 17a, an ordered set {1} is stored in the tracing-classloader-correspondence storage unit 17b, so that the tracing classloader 18c is generated. When the identifier “2” of the OtherLoader 15c is stored in the classloader-identifier storage unit 17a, the ordered set {2} is stored in the tracing-classloader-correspondence storage unit 17b, so that the tracing classloader 18c is generated.

Each of the tracing classloaders 18 has a priority-order storage unit 181 in which the order of priorities in which the tracing classloader 18 delegates a read of a class, and classloaders as delegation destinations are stored to be associated with each other. When a tracing classloader 18 is generated by the tracing-classloader management unit 17, a reference of an object of a classloader being a value is stored in the priority-order storage unit 181 in association with the priority as a key according to a following policy. That is, the tracing classloader 18 stores a classloader having read a class of an object passed as an argument of the write method, the tracing classloader 18, and the SystemClassLoader 15a in the priority-order storage unit 181 in the decreasing order of the priorities described above from a highest priority class loader.

Referring to the priority-order storage unit 181, the tracing classloader 18 delegates a read of a class to classloaders in the decreasing order of the priorities from a highest priority classloader when a read of a class is requested by the tracing-classloader management unit 17. At that time, when a classloader as a delegation destination is not able to refer to the storage position of a class file corresponding to this request, the tracing classloader 18 fails in the read of the class. In this case, the tracing classloader 18 delegates the read of the class to a classloader having a highest priority next to the classloader having failed in the read of the class. When all classloaders stored in the priority-order storage unit 181 fail in the read, the tracing classloader 18 terminates the read and outputs an exception. In this case, there is a high possibility that a failure in the read of the class is not an error in the tracing classloader 18 but an error in the execution-trace output process.

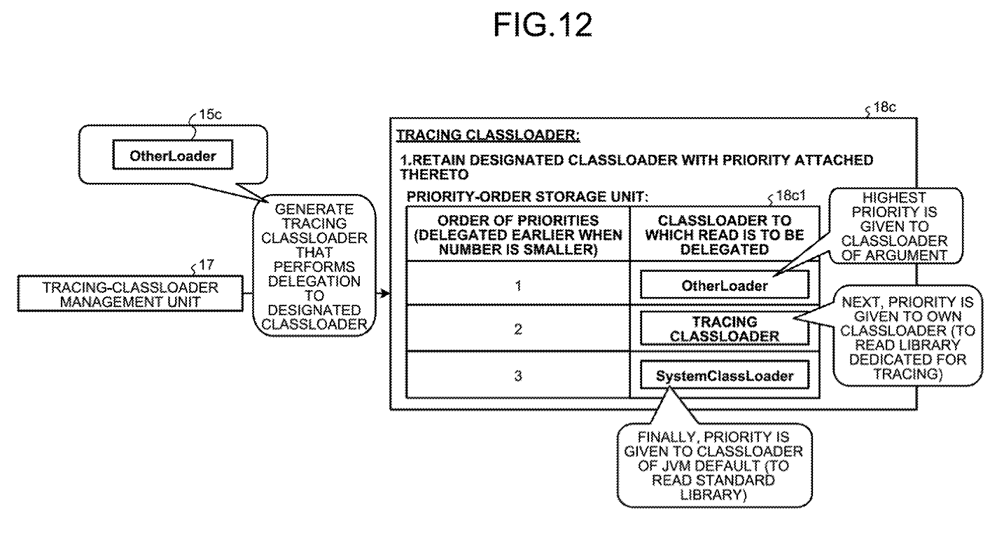

FIG. 12 is a diagram illustrating an example of a method of setting the order of priorities. In FIG. 12, a case where the tracing classloader 18c is generated in a state where the OtherLoader 15c is designated by the tracing-classloader management unit 17 as a classloader to which a read of a class is delegated is assumed. In this case, as illustrated in FIG. 12, the OtherLoader 15c having read a class of an object passed as an argument of the write method, the tracing classloader 18c, and the SystemClassLoader 15a described above are stored in a priority-order storage unit 18c1 in the decreasing order of the priorities from a highest priority classloader.

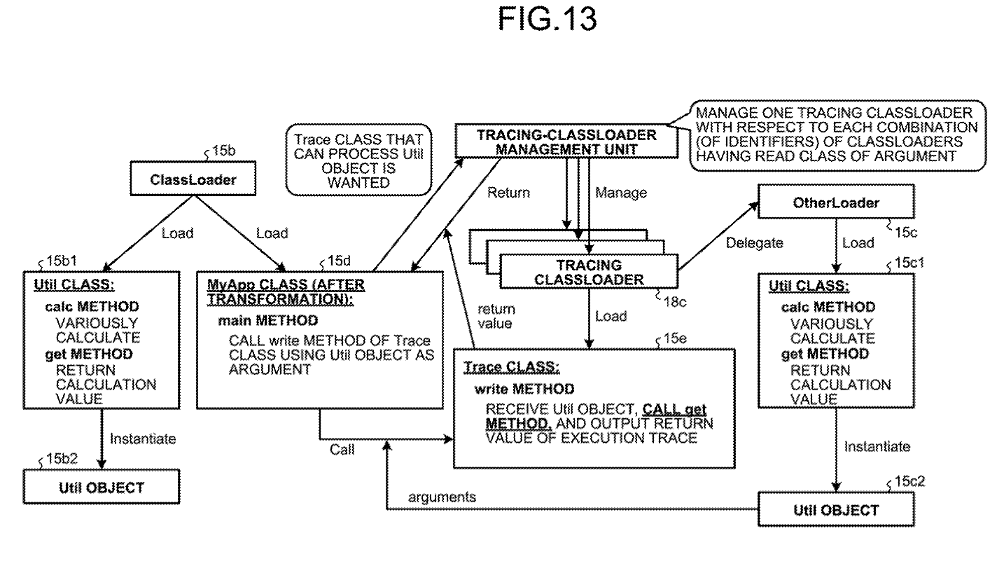

FIG. 13 is a diagram illustrating an example of a correlation among classes and objects. In FIG. 13, classes read by the ClassLoader 15b and an object generated from the classes, and a class read by the OtherLoader 15c and an object generated from the class are illustrated similarly to FIG. 8.

The example of FIG. 13 is different from the example of FIG. 8 in including the tracing-classloader management unit 17 and the tracing classloader 18c generated by the tracing-classloader management unit 17, as explained with reference to FIG. 12. When a read of a class is requested by the tracing-classloader management unit 17, the tracing classloader 18c delegates the read of the class according to the order of priorities stored in the priority-order storage unit 18c1. Accordingly, “names of other classes” included in the definition of the Trace class 15e are all interpreted by the tracing classloader 18c. Therefore, even when a class of the same name is managed by a classloader other than the OtherLoader 15c, the class managed by the OtherLoader 15c is given the highest priority. As a result, when a call expression for the write method of the Trace class 15e is to be executed, the type can be transformed to the class managed by the OtherLoader 15c that has read a class obtained by instantiating an object passed as the argument of the write method. In other words, type transformation to a class with the same name managed by the ClassLoader 15b different from the OtherLoader 15c can be suppressed. Therefore, occurrence of a cast error can be suppressed.

Process Flow

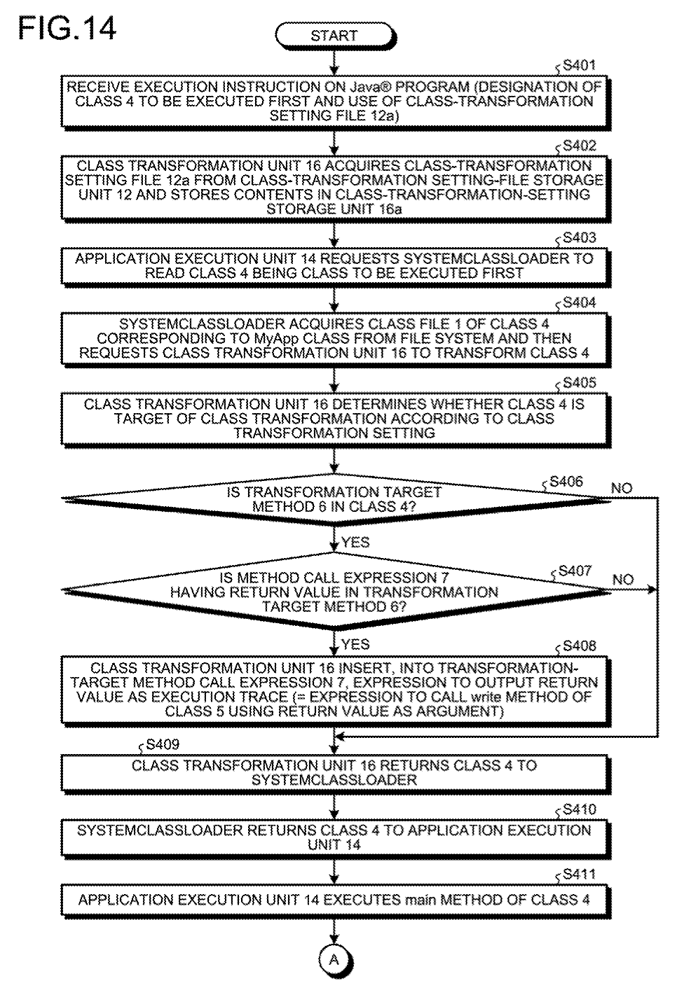

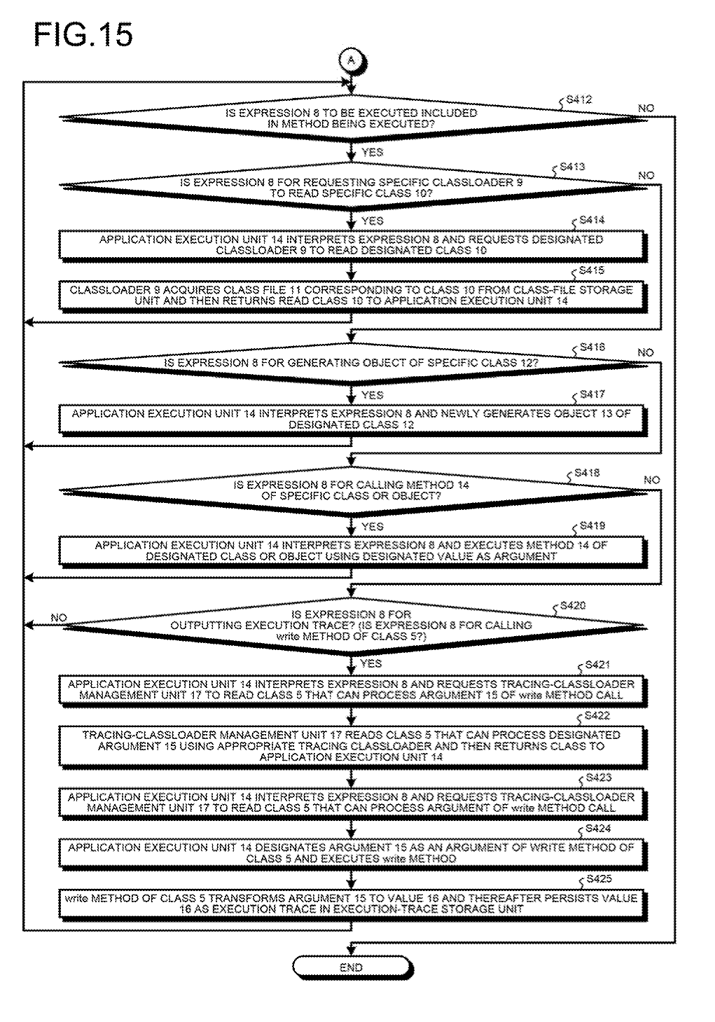

A flow of processes performed by the information processing apparatus 10 according to the present embodiment is described next. FIGS. 14 and 15 are flowcharts illustrating a procedure of a tracing process according to the first embodiment. As illustrated in FIG. 14, the application execution unit 14 receives an execution instruction on a Java® program (designation of a class 4 to be executed first and use of the class-transformation setting file 12a) via an input device or a network (Step S401).

The class transformation unit 16 then acquires the class-transformation setting file 12a from the class-transformation setting-file storage unit 12 and stores the acquired contents in the class-transformation-setting storage unit 16a (Step S402).

Subsequently, the application execution unit 14 requests the SystemClassLoader 15a to read the class 4 being the class to be executed first (Step S403). Next, the SystemClassLoader 15a acquires a class file 1 corresponding to the class 4 from the file system and then requests the class transformation unit 16 to transform the class 4 (Step S404).

Subsequently, the class transformation unit 16 determines whether the class 4 is a target of class transformation according to the class transformation setting (Step S405). At that time, when a method 6 being a transformation target is in the class 4 and a method call expression 7 having a return value is in the method 6 being the transformation target (YES at Step S406 and YES at Step S407), the class transformation unit 16 inserts, into the method call expression 7 being the transformation target, an expression to output a return value thereof as an execution trace (=expression to call a write method of a class 5 using the return value as an argument) (Step S408). Next, the class transformation unit 16 returns the class 4 to the SystemClassLoader 15a (Step S409).

For example, when the MyApp class 15d is designated as the class 4, the main method included in the MyApp class 15d corresponds to the method 6 being the transformation target and Util.calc( ) of a return value type is included in the main method, so that branches at Steps S406 and S407 are both determined as YES. In this case, the output process of the execution trace defined in the Trace class file 11c is inserted into the MyApp class file 11a as illustrated in FIG. 3.

On the other hand, when the method 6 being the transformation target is not included in the class 4 or the method call expression 7 having a return value is not included in the method 6 being the transformation target (NO at Step S406 or NO at Step S407), the process at Step S408 is skipped to perform the process at Step S409.

The SystemClassLoader 15a returns the class 4 to the application execution unit 14 (Step S410). The application execution unit 14 then executes the main method of the class 4 (Step S411).

Subsequently, as illustrated in FIG. 15, as long as an expression 8 having not been executed yet is included in the method being executed (YES at Step S412), following processes from Step S413 to Step S425 are repeatedly performed. That is, when the expression 8 is for requesting a specific classloader 9 to read a specific class 10 (YES at Step S413), the application execution unit 14 interprets the expression 8 and requests the designated classloader 9 to read the designated class 10 (Step S414). The classloader 9 acquires a class file 11 corresponding to the class 10 from the class-file storage unit 11 and then returns the read class 10 to the application execution unit 14 (Step S415), and the process proceeds to Step S412. These processes at Step S414 and Step S415 correspond to a process in which the ClassLoader 15b reads the Util class 15b1 or a process in which the OtherLoader 15c reads the Util class 15c1 as an example.

On the other hand, when the expression 8 is not for requesting a specific classloader 9 to read a specific class 10 and the expression 8 is for generating an object of a specific class 12 (NO at Step S413 and YES at Step S416), the application execution unit 14 interprets the expression 8 and newly generates an object 13 of the designated class 12 (Step S417). This corresponds to a process of generating the Util object 15b2 by instantiating the Util class 15b1 or a process of generating the Util object 15c2 by instantiating the Util class 15c1 as an example.

When the expression 8 is for calling a method 14 of a specific class or object (YES at Step S418), the application execution unit 14 interprets the expression 8 and executes the method 14 of the designated class or object using a designated value as an argument (Step S419) and the process proceeds to Step S412. Examples of the method that meets the condition of YES at Step S418 include Util.calc( ).

When the expression 8 is the output process of an execution trace, that is, the expression 8 is for calling a write method of the class 5 (YES at Step S420), the application execution unit 14 interprets the expression 8 and requests the tracing-classloader management unit 17 to read the class 5 that can process an argument 15 of a write method call (Step S421).

The tracing-classloader management unit 17 then reads the class 5 that can process the designated argument 15 using an appropriate tracing classloader 18 and then returns the class 5 to the application execution unit 14 (Step S422).

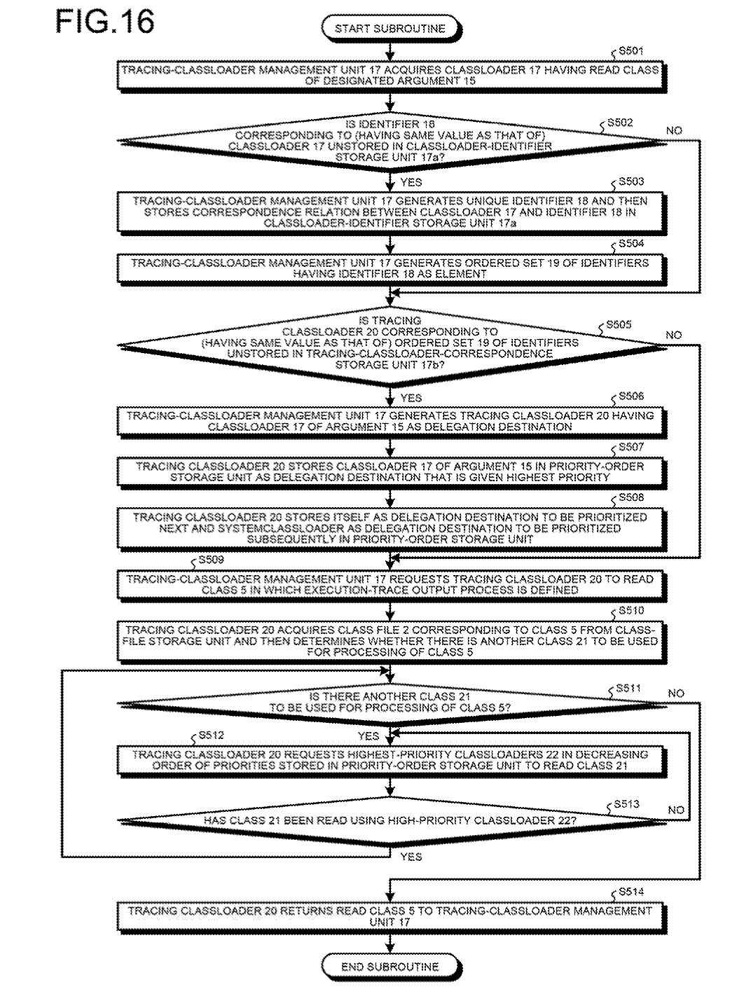

A subroutine of the process at Step S422 is described with reference to FIG. 16. FIG. 16 is a flowchart illustrating a subroutine of the tracing process according to the first embodiment. This process corresponds to the process at Step S422 illustrated in FIG. 15. As illustrated in FIG. 16, the tracing-classloader management unit 17 acquires a classloader 17 having read a class of the designated argument 15 (Step S501).

At that time, when an identifier 18 corresponding to (having the same value as that of) the classloader 17 is not stored yet in the classloader-identifier storage unit 17a (YES at Step S502), the tracing-classloader management unit 17 generates a unique identifier 18 and then stores a correspondence relation between the classloader 17 and the identifier 18 in the classloader-identifier storage unit 17a (Step S503). The tracing-classloader management unit 17 then generates an ordered set 19 of identifiers having the identifier 18 as an element (Step S504). When the identifier 18 corresponding to the classloader 17 is stored in the classloader-identifier storage unit 17a (NO at Step S502), the processes at Step S503 and Step S504 are skipped to proceed to a process at Step S505.

When a tracing classloader 20 corresponding to (having a same value as that of) the ordered set 19 of identifiers is not stored yet in the tracing-classloader-correspondence storage unit 17b (YES at Step S505), the tracing-classloader management unit 17 generates the tracing classloader 20 having the classloader 17 of the argument 15 as a delegation destination (Step S506). When the tracing classloader 20 corresponding to the ordered set 19 of identifiers is stored in the tracing-classloader-correspondence storage unit 17b (NO at Step S505), the process proceeds to Step S509.

The tracing classloader 20 then stores the classloader 17 of the argument 15 in the priority-order storage unit as a delegation destination that is given a highest priority (Step S507). The tracing classloader 20 also stores itself (the tracing classloader 20) as a delegation destination that is prioritized next and the SystemClassLoader 15a as a delegation destination that is prioritized subsequently in the priority-order storage unit (Step S508).

The tracing-classloader management unit 17 requests the tracing classloader 20 to read the class 5 in which the execution-trace output process is defined (Step S509). The tracing classloader 20 then acquires a class file 2 corresponding to the class 5 from the class-file storage unit and then determines whether there is another class 21 to be used for the processing of the class 5 (Step S510).

At that time, when there is another class 21 to be used for the processing of the class 5 (YES at Step S511), the tracing classloader 20 requests high-priority classloaders 22 in the decreasing order of priorities stored in the priority-order storage unit to read the class 21 (Step S512). Until the class 21 has been read using the high-priority classloader 22 (NO at Step S513), the process at Step S512 described above is repeatedly performed.

Thereafter, when there is no other class 21 to be used for the processing of the class 5 (NO at Step S511), the tracing classloader 20 returns the read class 5 to the tracing-classloader management unit 17 (Step S514) and ends the subroutine.

Returning to the explanations of FIG. 15, when the process at Step S422 ends, the application execution unit 14 interprets the expression 8 and requests the tracing-classloader management unit 17 to read the class 5 that can process the argument 15 of the write method call (Step S423).

The application execution unit 14 designates the argument 15 as an argument of the write method of the class 5 and executes the write method (Step S424). The write method of the class 5 then transforms the argument 15 to a value 16 and thereafter persists the value 16 as the execution trace in the execution-trace storage unit 13 (Step S425), and the process proceeds to Step S412.

One Aspect of Effects

As described above, when an execution-trace output process calls an object of a class for executing a Web application as an argument, the information processing apparatus 10 of the present embodiment performs type transformation to a class managed by a classloader that has read a class obtained by instantiating the object. Therefore, with the information processing apparatus 10 according to the present embodiment, occurrence of a cast error can be suppressed.

Additionally, with the information processing apparatus 10 according to the present embodiment, maintainability of an execution-trace output process can be enhanced. That is, recently, even a large-scaled and complicated Web application such as a business application has been realized by combining a plurality of pieces of OSS without being self-developed. Because of this background, the need to minimize changes in source codes of the OSS and check the behavior of the OSS from various viewpoints arises increasingly. In this case, the developer of the OSS and the developer of the execution-trace output process are in different sections and various hypothesis verifications need to be performed repeatedly for checking. For these reasons, utilization of the development support functions is promoted, so that the maintainability of the execution-trace output process can also be enhanced.

### [b] Second Embodiment

While an embodiment related to the disclosed apparatus has been described above, the present invention can be also carried out by various different embodiments other than the embodiment described above. In the following descriptions, another embodiment included in the present invention is described.

Distribution and Integration

The respective constituent elements of respective devices illustrated in the drawings do not always need to be physically configured as illustrated in the drawings. All or a part thereof can be functionally or physically distributed or integrated in an arbitrary unit according to various kinds of load and status of use. For example, the application execution unit 14, the class storage unit 15, the class transformation unit 16, the tracing-classloader management unit 17, or the tracing classloaders 18 can be connected via a network as an external device of the information processing apparatus 10. Further, the functions of the information processing apparatus 10 described above can be realized as the application execution unit 14, the class storage unit 15, the class transformation unit 16, the tracing-classloader management unit 17, or the tracing classloaders 18 are respectively included in another apparatus to cooperate to each other while being connected via a network.

Occurrence of a cast error at the time of tracing can be suppressed.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A tracing method comprising:
receiving, by a processor, a read of a class file created using an object-oriented program language;
when a class of the class file is a tracing target, performing class transformation to insert a tracing output process into the class file, by the processor;
when the tracing output process is called during execution of a class file having been subjected to the class transformation, generating a first classloader that reads a tracing class file corresponding to the tracing output process, by the processor;
setting, for each the first classloader, an order of priorities in which the first classloader delegates a read of a class in such a manner that a second classloader having read a class of an object to be passed as an argument to the tracing output process has a highest priority, by the processor; and
when a request to the first classloader for a read of a class is issued, causing the first classloader to delegate the read of the class to classloaders in a decreasing order of the priorities from the highest-priority classloader, by the processor.

2. The tracing method according to claim 1, wherein the setting includes setting priorities that are given to the second classloader, the first classloader, and a system classloader in a decreasing order of the priorities.

3. The tracing method according to claim 1, wherein the tracing output process is a process of outputting an execution result or a process of outputting an internal call result.

4. A non-transitory computer-readable recording medium having stored therein a tracing program that causes a computer to execute a process comprising:
receiving a read of a class file created using an object-oriented program language;
when a class of the class file is a tracing target, performing class transformation to insert a tracing output process into the class file;
when the tracing output process is called during execution of a class file having been subjected to the class transformation, generating a first classloader that reads a tracing class file corresponding to the tracing output process;
setting, for each the first classloader, an order of priorities in which the first classloader delegates a read of a class in such a manner that a second classloader having read a class of an object to be passed as an argument to the tracing output process has a highest priority; and
when a request to the first classloader for a read of a class is issued, causing the first classloader to delegate the read of the class to classloaders in a decreasing order of the priorities from the highest-priority classloader.

5. The non-transitory computer-readable recording medium according to claim 4, wherein the setting includes setting priorities that are given to the second classloader, the first classloader, and a system classloader in a decreasing order of the priorities.

6. The non-transitory computer-readable recording medium according to claim 4, wherein the tracing output process is a process of outputting an execution result or a process of outputting an internal call result.

7. An information processing apparatus comprising:
a processor configured to:
receive a read of a class file created using an object-oriented program language;
when a class of the class file is a tracing target, perform class transformation to insert a tracing output process into the class file;
when the tracing output process is called during execution of a class file having been subjected to the class transformation, generate a first classloader that reads a tracing class file corresponding to the tracing output process;
set, for each the first classloader, an order of priorities in which the first classloader delegates a read of a class in such a manner that a second classloader having read a class of an object to be passed as an argument to the tracing output process has a highest priority; and
when a request to the first classloader for a read of a class is issued, cause the first classloader to delegate the read of the class to classloaders in a decreasing order of the priorities from the highest-priority classloader.

8. The information processing apparatus according to claim 7, wherein the processor is configured to set priorities that are given to the second classloader, the first classloader, and a system classloader in a decreasing order of the priorities.

9. The information processing apparatus according to claim 7, wherein the tracing output process is a process of outputting an execution result or a process of outputting an internal call result.
